(19) United States
(12) Patent Application Publication
(10) Pub. No.: US 2016/0308776 A1
(43) Pub. Date: Oct. 20, 2016

(54) ENHANCEMENTS FOR PDCP LAYER

(71) Applicant: QUALCOMM Incorporated, San Diego, CA (US)

(72) Inventors: Ozcan Ozturk, San Diego, CA (US); Jun Wang, Poway, CA (US)

(21) Appl. No.: 15/081,753

(22) Filed: Mar. 25, 2016

Related U.S. Application Data
(60) Provisional application No. 62/150,153, filed on Apr. 20, 2015.

(51) Int. Cl. H04L 12/805; H04L 12/893

(52) U.S. Cl. CPC H04L 47/365; H04L 47/40

(57) ABSTRACT

Methods, systems, and devices for wireless communication are described. A device may divide a packet data convergence protocol (PDCP) service data unit (SDU) into a set of PDCP segments based on a medium access control (MAC) layer transmission parameter, which may include a desired block size for MAC transmission or retransmission. The device may then append a PDCP header, generate one or more MAC protocol data unit (PDUs) and transmit the MAC PDUs. In some cases, information may be exchanged between the MAC layer and the PDCP layer to determine or signal the block size. A receiver may receive the MAC PDUs, identify multiple PDCP segment identifications (IDs) for PDCP PDUs that are generated from the received MAC PDUs, reorder the PDCP PDUs based on the PDCP segment IDs, and concatenate the PDCP PDUs before passing the data packets on to higher layers.

### CROSS REFERENCES

The present Application for Patent claims priority to U.S. Provisional Patent Application No. 62/150,153 by Ozturk, et al., entitled “Enhancements for PDCP Layer,” filed Apr. 20, 2015, assigned to the assignee hereof, and expressly incorporated by reference herein.

### BACKGROUND

The following relates generally to wireless communication, and more specifically to segmentation at the packet data convergence protocol (PDCP) layer.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system). A wireless multiple-access communications system may include a number of base stations, each simultaneously supporting communication for multiple communication devices, which may be otherwise known as user equipment (UE).

In some cases, data packets exchanged between a UE and a base station may be processed by one or more protocol layers ranging from application layers to the physical (PHY) layer. In some cases, data packets are segmented into appropriately sized blocks for transport by a radio link control (RLC) layer. Segmentation at the RLC layer may, however, result in redundant sequencing or inefficient use of processing resources.

### SUMMARY

A wireless communications device may divide a packet data convergence protocol (PDCP) service data unit (SDU) into a set of PDCP segments based on a medium access control (MAC) layer transmission parameter, which may include a desired block size for MAC transmission or retransmission. The wireless communications device may then append a PDCP header, generate one or more MAC protocol data unit (PDUs) and transmit the MAC PDUs. In some cases, information may be exchanged between the MAC layer and the PDCP layer to determine or signal the block size. A wireless communications device may also receive the MAC PDUs, and identify multiple PDCP segment identifications (IDs) for PDCP

PDUs that are generated from the received MAC PDUs. In some cases, the receiving wireless communications device may reorder the PDCP PDUs based on the PDCP segment IDs, and/or concatenate the PDCP PDUs before passing the data packets on to higher layers.

A method of wireless communication is described. The method may include dividing a PDCP SDU into a plurality of PDCP segments based at least in part on a MAC layer transmission parameter, generating one or more MAC PDUs from the plurality of PDCP segments, and transmitting the one or more MAC PDUs.

An apparatus for wireless communication is described. The apparatus may include means for dividing a PDCP SDU into a plurality of PDCP segments based at least in part on a MAC layer transmission parameter, means for generating one or more MAC PDUs from the plurality of PDCP segments, and means for transmitting the one or more MAC PDUs.

A further apparatus for wireless communication is described. The apparatus may include a processor, memory in electronic communication with the processor, and instructions stored in the memory and operable, when executed by the processor, to cause the apparatus to divide a PDCP SDU into a plurality of PDCP segments based at least in part on a

MAC layer transmission parameter, generate one or more MAC PDUs from the plurality of PDCP segments, and transmit the one or more MAC PDUs.

A non-transitory computer-readable medium storing code for wireless communication is described. The code may include instructions executable to divide a PDCP SDU into a plurality of PDCP segments based at least in part on a MAC layer transmission parameter, generate one or more MAC PDUs from the plurality of PDCP segments, and transmit the one or more MAC PDUs.

In some examples of the method, apparatuses, or non-transitory computer-readable medium described herein, the MAC layer transmission parameter comprises one or more of a MAC PDU size, a MAC retransmission segmentation probability, and a MAC retransmission size. Additionally or alternatively, some examples may include processes, features, means, or instructions for ciphering the plurality of PDCP segments, wherein the one or more MAC PDUs are generated based at least in part on the ciphering.

Some examples of the method, apparatuses, or non-transitory computer-readable medium described herein may further include processes, features, means, or instructions for appending PDCP headers to the plurality of PDCP segments, wherein the one or more MAC PDUs are generated based at least in part on PDCP segments with appended PDCP headers. Additionally or alternatively, some examples may include processes, features, means, or instructions for exchanging information between a MAC layer and a PDCP layer, wherein the MAC layer transmission parameter is based at least in part on the exchanged information.

Some examples of the method, apparatuses, or non-transitory computer-readable medium described herein may further include processes, features, means, or instructions for receiving PDCP PDU size feedback from a secondary base station, wherein dividing the PDCP SDU is based at least in part on the PDCP PDU size feedback. Additionally or alternatively, some examples may include processes, features, means, or instructions for establishing a split bearer dual connectivity configuration with a wireless device, wherein receiving the PDCP PDU size feedback from the secondary base station is based at least in part on the split bearer dual connectivity configuration.

Some examples of the method, apparatuses, or non-transitory computer-readable medium described herein may further include processes, features, means, or instructions for identifying a channel condition, wherein a size of a PDCP segment of the plurality of PDCP segments is based at least in part on the channel condition. Additionally or alternatively, some examples may include processes, features, means, or instructions for identifying a retransmission configuration, wherein dividing the PDCP SDU is based at least in part on the retransmission configuration.

In some examples of the method, apparatuses, or non-transitory computer-readable medium described herein, a PDCP segment of the plurality of PDCP segments comprises a segment indicator and a length field in a PDCP header. Additionally or alternatively, in some examples the one or more MAC PDUs comprise the segment indicator and the length field for the PDCP segment in one or more corresponding MAC headers. Some examples of the method, apparatuses, or non-transitory computer-readable medium described herein may further include processes, features, means, or instructions for resegmenting the one or more MAC PDUs at a PDCP PDU boundary, wherein the one or more resegmented MAC PDUs comprise one or more non-segmented PDCP PDUs.

A method of wireless communication is described. The method may include receiving one or more MAC PDUs, generating a plurality of PDCP PDUs from the one or more MAC PDUs, and identifying a plurality of PDCP segment IDs for the plurality of PDCP PDUs.

An apparatus for wireless communication is described. The apparatus may include means for receiving one or more MAC PDUs, means for generating a plurality of PDCP PDUs from the one or more MAC PDUs, and means for identifying a plurality of PDCP segment IDs for the plurality of PDCP PDUs.

A further apparatus for wireless communication is described. The apparatus may include a processor, memory in electronic communication with the processor, and instructions stored in the memory and operable, when executed by the processor, to cause the apparatus to receive one or more MAC PDUs, generate a plurality of PDCP PDUs from the one or more MAC PDUs, and identify a plurality of PDCP segment IDs for the plurality of PDCP PDUs.

A non-transitory computer-readable medium storing code for wireless communication is described. The code may include instructions executable to receive one or more MAC PDUs, generate a plurality of PDCP PDUs from the one or more MAC PDUs, and identify a plurality of PDCP segment IDs for the plurality of PDCP PDUs.

Some examples of the method, apparatuses, or non-transitory computer-readable medium described herein may further include processes, features, means, or instructions for determining that the plurality PDCP PDUs comprise a PDCP SDU based at least in part on the plurality of PDCP segment IDs, and concatenating the plurality of PDCP PDUs into the

PDCP SDU based at least in part on the determination. Additionally or alternatively, some examples may include processes, features, means, or instructions for reordering the plurality of PDCP PDUs based at least in part on the plurality of PDCP segment IDs, wherein the concatenation is based at least in part on the reordering.

Some examples of the method, apparatuses, or non-transitory computer-readable medium described herein may further include processes, features, means, or instructions for determining that the plurality PDCP PDUs is insufficient to generate a PDCP SDU based at least in part on the plurality of PDCP segment IDs, and dropping the plurality of PDCP PDUs based at least in part on the determination. Additionally or alternatively, some examples may include processes, features, means, or instructions for determining that the plurality of PDCP PDUs comprises a beginning portion of a PDCP SDU based at least in part on the plurality of PDCP segment IDs, and delivering the beginning portion of the PDCP SDU to a higher layer based at least in part on the determination.

### BRIEF DESCRIPTION OF THE DRAWINGS

Aspects of the disclosure are described in reference to the following figures:

FIG. 1 illustrates an example of a wireless communications system that supports segmentation at the packet data convergence protocol (PDCP) layer in accordance with various aspects of the present disclosure;

FIG. 2 illustrates an example of a wireless communications system that supports segmentation at the PDCP layer in accordance with various aspects of the present disclosure;

FIGS. 3-4 illustrate examples of protocol layer structures for segmentation at the PDCP layer in accordance with various aspects of the present disclosure;

FIG. 5 illustrates an example of a process flow in a system that supports segmentation at the PDCP layer in accordance with various aspects of the present disclosure;

FIGS. 6-7 show diagrams of a wireless communications device that supports segmentation at the PDCP layer in accordance with various aspects of the present disclosure;

FIG. 8 shows a diagram of a PDCP segmentation module which may be a component of a wireless communications device and which may support segmentation at the PDCP layer in accordance with various aspects of the present disclosure;

FIG. 9 shows a diagram of a system including a UE that supports segmentation at the PDCP layer in accordance with various aspects of the present disclosure;

FIG. 10 shows a diagram of a system including a base station that supports segmentation at the PDCP layer in accordance with various aspects of the present disclosure; and

FIGS. 11-17 show flowcharts illustrating methods for segmentation at the PDCP layer in accordance with various aspects of the present disclosure.

### DETAILED DESCRIPTION

In some wireless communication systems, a radio link control (RLC) layer may perform packet (e.g., service data unit (SDU)) segmentation, concatenation, and retransmission. If RLC is not used, segmentation functionality may be handled at other layers. Specifically, segmentation may be done at the media access control (MAC) or packet data convergence protocol (PDCP) layers. In either case, concatenation can be done at the MAC layer and retransmission can be done at the physical (PHY) or MAC layer. In a scheme that employs MAC segmentation without RLC, the MAC layer may be responsible for reordering segments that arrive out-of-order. But because the PDCP layer already does reordering, another option is to designate the segmentation functions to the PDCP layer. This may enable a single reordering layer, and may enable reuse of PDCP layer sequence numbering fields.

The PDCP layer may handle various functions, such as ciphering and header compression. A PDCP protocol data unit (PDU) segment size may depend on channel conditions. For example, the PDCP PDU size may be selected according to predicted temporal channel condition and scheduling resources. Similarly, a scheduler can take into account a retransmission configuration. For example, if no retransmission is configured, one PDCP PDU per MAC PDU may be selected as an appropriate size.

For a transmitting device (e.g., a transmitting wireless communications devices), PDCP PDU granularity may be determined by the scheduler. For example, it may be based on the MAC PDU size. In some cases, the size may be semi-statically configured, or may depend on other system configurations or parameters. For a dual connectivity split bearer, for example, the desired PDCP PDU size at a secondary base station may be communicated to the master base station. Since there may be no length field in a PDCP header, multiple segments may not be included in a single PDCP PDU. However, a scheduler jointly operating across MAC and PDCP layers can minimize these consequences.

For a receiving device, SDUs may be sent to upper layers in order if PDCP does reordering. However, if RLC in acknowledged mode (AM) is not used, there may be missing PDCP PDUs. Thus, a method for reconstructing PDCP SDUs may be used. PDCP SDUs (e.g., internet protocol (IP) packets) may be transmitted in multiple PDCP PDUs. In some cases, a segment indicator and length fields may be used in the PDCP header to determine to which part of the PDCP SDU each PDCP PDU corresponds. Segment indicator fields may also be placed in the MAC header.

In some cases, the size of a PDCP PDU may be selected to minimize the probability of MAC segmentation during retransmission, or to enable multiplexing of several PDCP PDUs into one MAC PDU, where the one MAC PDU may be sent in several disjoint MAC PDUs during retransmissions. In some cases, a PDCP SDU may be passed to upper layers after all PDCP PDUs are received.

Aspects of the disclosure are initially described in the context of a wireless communication system. Specific examples are described for generating PDCP PDUs and MAC PDUs. These and other aspects of the disclosure are further illustrated by and described with reference to apparatus diagrams, system diagrams, and flowcharts that relate to segmentation at the PDCP layer.

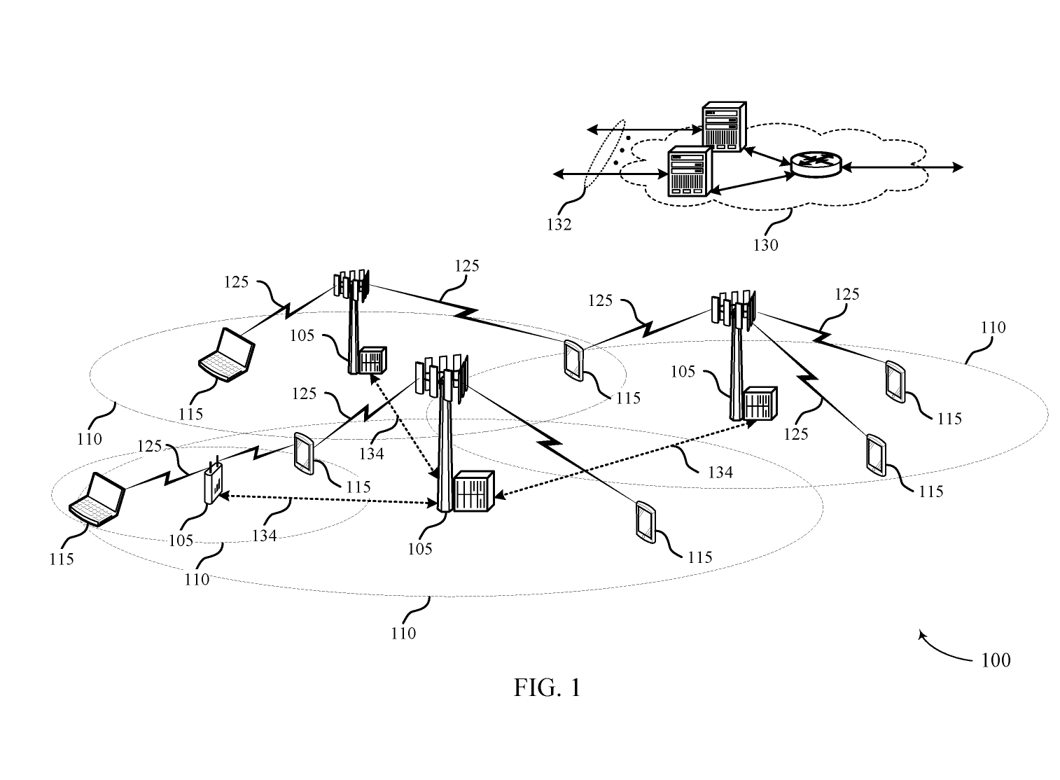

FIG. 1 illustrates an example of a wireless communications system 100 that supports segmentation at the PDCP layer in accordance with various aspects of the present disclosure. The wireless communications system 100 includes base stations 105, UEs 115, and a core network 130. In some examples, the wireless communications system 100 may be a Long Term Evolution (LTE)/LTE-Advanced (LTE-A) network. UEs 115 and base stations 105 may communicate using multiple protocol layers, and in some cases, packet segmentation may be handled by the PDCP layer.

Base stations 105 may wirelessly communicate with UEs 115 via one or more base station antennas. Each base station 105 may provide communication coverage for a respective geographic coverage area 110. Communication links 125 shown in wireless communications system 100 may include uplink (UL) transmissions from a UE 115 to a base station 105, or downlink (DL) transmissions, from a base station 105 to a UE 115. UEs 115 may be dispersed throughout the wireless communications system 100, and each UE 115 may be stationary or mobile. A UE 115 may also be referred to as a mobile station, a subscriber station, a remote unit, a wireless communications device, an access terminal, a handset, a user agent, a client, or some other suitable terminology. A UE 115 may also be a cellular phone, a wireless modem, a handheld device, a personal computer, a tablet, a personal electronic device, a machine type communication (MTC) device or the like.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105.

Wireless communications system 100 may be based on a layered protocol system, which may include an IP layer, a PDCP layer, an RLC layer, a MAC layer, and a PHY layer. The PDCP layer may be responsible for receiving IP packets, performing header compression and decompression using, for instance, a robust header compression (ROHC) protocol, transfer of data (user plane or control plane), maintenance of PDCP sequence numbers (SNs), and in-sequence delivery of upper layer PDUs to lower layers. The PDCP layer may also manage elimination of duplicate packets, ciphering and deciphering of user plane data and control plane data, integrity protection and integrity verification of control plane data, and packet discard based on a time-out timer.

An RLC layer may connect higher layers (e.g., the PDCP layer) to the lower layers (e.g., the MAC layer). An RLC entity in a base station 105 or a UE 115 may ensure that transmission packets are organized into appropriately sized blocks (e.g., corresponding to the MAC layer transport block (TB) size). If an incoming data packet (e.g., a PDCP or radio resource control (RRC) SDU) is too big for transmission, the RLC layer may segment it into several smaller RLC PDUs. If the incoming packets are too small, the RLC layer may concatenate several of them into a single, larger RLC PDU. Each RLC PDU may include a header including information about how to reassemble the data. The RLC layer may also ensure that packets are reliably transmitted. The transmitter may keep a buffer of indexed RLC PDUs, and continue retransmission of each PDU until it receives the corresponding acknowledgement (ACK).

In some cases, the transmitter may send a Poll Request to determine which PDUs have been received and the receiver may respond with a Status Report. Unlike the MAC layer hybrid automatic repeat request (HARQ), RLC automatic repeat request (ARQ) may not include a forward error correction function. An RLC entity may operate in one of three modes: AM, unacknowledged mode (UM), or transparent mode (TM). In AM, the RLC entity may perform segmentation/concatenation and ARQ. This mode may be appropriate for delay tolerant or error sensitive transmissions. In UM, the RLC entity may perform segmentation/concatenation but not ARQ. This may be appropriate for delay sensitive or error tolerant traffic (e.g., voice over Long Term evolution (VoLTE)). TM performs data buffering, but may not include either concatenation/segmentation or ARQ. TM may be used primarily for sending broadcast control information (e.g., master information blocks (MIBs) and system information blocks (SIBs)), paging messages, and RRC connection messages. Some transmissions may be sent without RLC (e.g., a random access channel (RACH) preamble and response).

In some wireless networks, some or all of the functions of the RLC layer may be performed by the PDCP layer for certain communications. In these circumstances, the RLC layer may be omitted and the PDCP layer may exchange packets directly with the MAC layer.

The MAC layer may perform mapping between logical and transport channels, prioritize channels, perform dynamic scheduling, and provide error correction, such as HARQ. HARQ may be a method of ensuring that data is received correctly over a communication link 125 by performing a combination of error detection (e.g., using a cyclic redundancy check (CRC)), forward error correction (FEC), and retransmission (e.g., ARQ). HARQ may improve throughput at the MAC layer in poor radio conditions (e.g., signal-to-noise conditions). In Incremental Redundancy HARQ, incorrectly received data may be stored in a buffer and combined with subsequent transmissions to improve the overall likelihood of successfully decoding the data. In some cases, redundancy bits are added to each message prior to transmission. This may be especially useful in poor conditions. In other cases, redundancy bits are not added to each transmission, but are retransmitted after the transmitter of the original message receives a negative acknowledgement (NACK or NAK) indicating a failed attempt to decode the information. The chain of transmission, response, and retransmission may be referred to as a HARQ process. In some instances, a limited number of HARQ processes may be used for a given communication link 125.

In some cases, a UE 115 may be served by cells from two or more base stations 105 in dual connectivity operation. In some examples, dual-connectivity techniques may be employed when serving base stations 105 are connected by a non-ideal backhaul link 134, which may not be sufficient to facilitate precise timing coordination between the base stations 105. Thus, in some cases, the cells serving a UE 115 may be divided into multiple timing adjustment groups (TAGs). Each TAG may be associated with a different timing offset, such that the UE 115 may synchronize uplink UL differently for different UL carriers. In dual connectivity operation, multiple base stations 105 may coordinate to determine appropriate parameters for segmenting data packets or performing other functions at the PDCP layer.

Thus, a base station 105 or UE 115 may divide a PDCP SDU into a set of PDCP segments based on a MAC layer transmission parameter, such as a desired MAC PDU size. The base station 105 or UE 115 may then append a PDCP header, generate one or more MAC PDUs, and transmit the MAC PDUs. In some cases, information may be exchanged between the MAC layer and the PDCP layer to determine or signal the block size. A receiver may receive the MAC PDUs, identify multiple PDCP segment identifications (IDs) for the PDCP segments, reorder the segments based on the PDCP segment IDs, and concatenate the segments before passing the data packets on to higher layers.

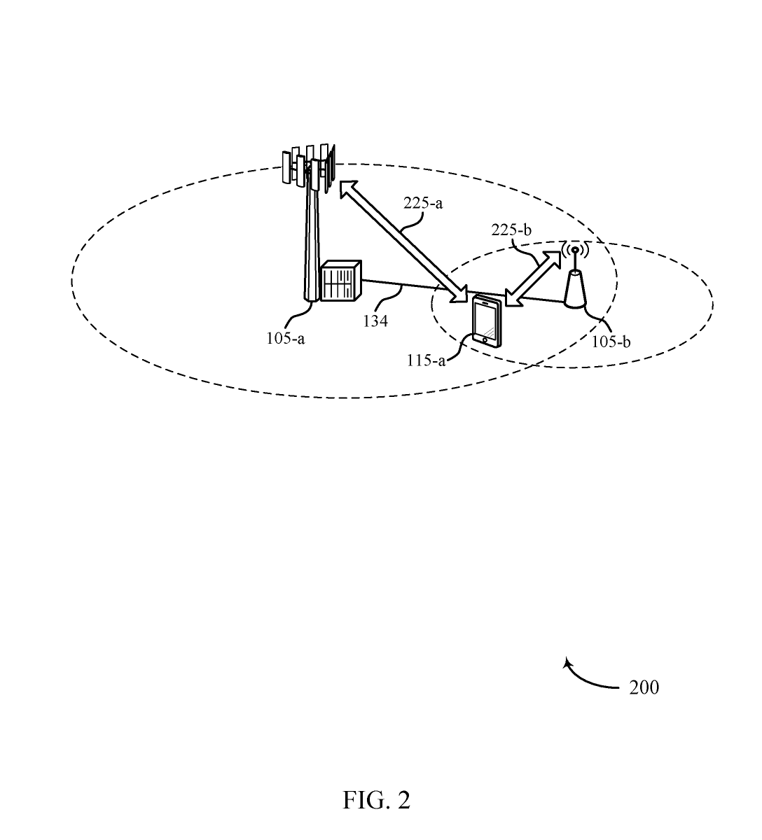

FIG. 2 illustrates an example of a wireless communications system 200 that supports segmentation at the PDCP layer in accordance with various aspects of the present disclosure. Wireless communications system 200 may include a UE 115-a, base station 105-a, and base station 105-b, which may be examples of a UE 115 and a base station 105 described with reference to FIG. 1. Although as illustrated, UE 115-a is communicating with both base station 105-a and base station 105-b via communication links 225-a and 225-b, the description herein may also apply when UE 115-a is communicating with one base station 105 or more than two base stations 105.

In some cases, UE 115-a may communicate with base station 105-a and base station 105-b in a dual connectivity split bearer configuration. In such examples, feedback (such as a desired PDCP PDU size) may be conveyed from a secondary base station 105-b to a primary base station 105-a. The periodicity of this feedback may be on the order of tens of milliseconds, and may be based on a delay associated with backhaul link 134. In some cases, a split bearer may be correlated with a good backhaul link 134, even if the backhaul link 134 is non-ideal or suboptimal.

Wireless communications system 200 may illustrate an example of devices communicating without an RLC layer, or with some or all RLC functions performed at the PDCP layer. For example, segmentation and concatenation may be done at the PDCP layer.

In other examples, concatenation can be done at the MAC layer and retransmission can be done at the PHY or MAC layer. Under MAC segmentation without RLC, the MAC layer may be responsible for reordering segments that arrive out-of-order. But, as mentioned above, segmentation functions may be performed at the PDCP layer because the PDCP layer already does reordering. This may enable a single reordering layer, and may enable reuse of PDCP layer sequence numbering fields.

The PDCP layer may handle functions, including ciphering and header compression. For example, data, such as an IP packet, may be assigned a SN (e.g., 7, 12, or 15 bits), which may optionally be compressed using ROHC, and may be ciphered. To enabled segmentation, additional bits may be used in the header to indicate the segments. For example, three (3) reserved bits in a 12-bit SN may be used for segment indication. 7-bit SNs (e.g., for RLC UM) and 15-bit SNs (e.g., for transmission on the central carrier or for Wi-Fi aggregation) may not have any reserved bits and may be augmented with additional bits. Since each PDCP PDU may be byte aligned, introducing additional bits for 7- and 15-bits may involve adding an additional byte.

In some cases, the PDCP PDU segment size may depend on the channel conditions. For example, the PDCP PDU size may be selected according to predicted temporal channel conditions and scheduling resource variability. For instance, a smaller size PDCP PDU may be chosen when the scheduler anticipates fewer resources or worse channel conditions for retransmission, but a larger size (e.g., one PDCP PDU per MAC PDU) may be chosen when more resources or better channel conditions are available. Similarly, a scheduler can take into account the retransmission configuration. For example, if no retransmission is configured, one PDCP PDU per MAC may be appropriate. Thus, for base station 105-a, the PDCP PDU granularity may be determined by the scheduler. For example, it may be based on the MAC PDU size. In some cases, PDCP PDU granularity may be semi-statically configured. Since there may be no length field in the PDCP header, multiple segments may not be included in a single PDCP PDU, but a scheduler jointly operating across MAC and PDCP layers can minimize consequences of not including multiple segments in a single PDCP PDU.

At a receiving device, SDUs may be sent to upper layers in order if the PDCP layer does reordering. But if RLC AM is not used, there may be missing PDCP PDUs. Thus, a method for reconstructing PDCP SDUs may be used. In some cases, with a 12-bit SN two of the three reserved bits can be used to indicate segments. For example, the same format may be used as for the Framing Info (FI) field in RLC. Thus, the FI may have two bits, which may convey information as follows: 00 for a complete SDU, 01 for the beginning of an SDU, 10 for the last part of the SDU, and 11 for the middle of the SDU. The PDCP reordering function may pass an SDU to upper layers when all segments are received and drop all associated segments if a whole SDU is not able to be constructed. In some cases, the MAC may identify the FI and exchange this information with the PDCP layer.

Thus, PDCP SDUs (e.g., IP packets) may be transmitted in multiple PDCP PDUs. In some cases, a segment indicator and length fields may be used in the PDCP header to determine which part of the PDCP SDU each PDCP PDU corresponds to. The segment indicator fields may also be placed in the MAC header. The PDCP PDU size may be selected according to the MAC scheduler output. In some cases, the size may be selected so that one PDCP PDU is transmitted in one MAC PDU (e.g., if no retransmission is used at the MAC layer). In some cases, the size of the PDCP PDU may be selected to minimize the probability of MAC segmentation during retransmission. The size may be selected to enable multiplexing of several PDCP PDUs into one MAC PDU to be sent in several disjoint MAC PDUs during retransmissions. In some cases, the PDCP layer may communicate with the MAC layer for PDCP PDU boundaries which may be used to determine the TB sizes in retransmissions. In some examples, a PDCP SDU may be passed to upper layers after all PDCP PDUs are received. Feedback may be sent from a secondary base station to the master base station in a dual connectivity configuration to determine the desired PDCP PDU size. In some cases, the MAC PDUs may be resegmented at the PDCP PDU boundaries. For example, resegmentation may ensure that a receiver gets complete PDCP PDUs after retransmissions.

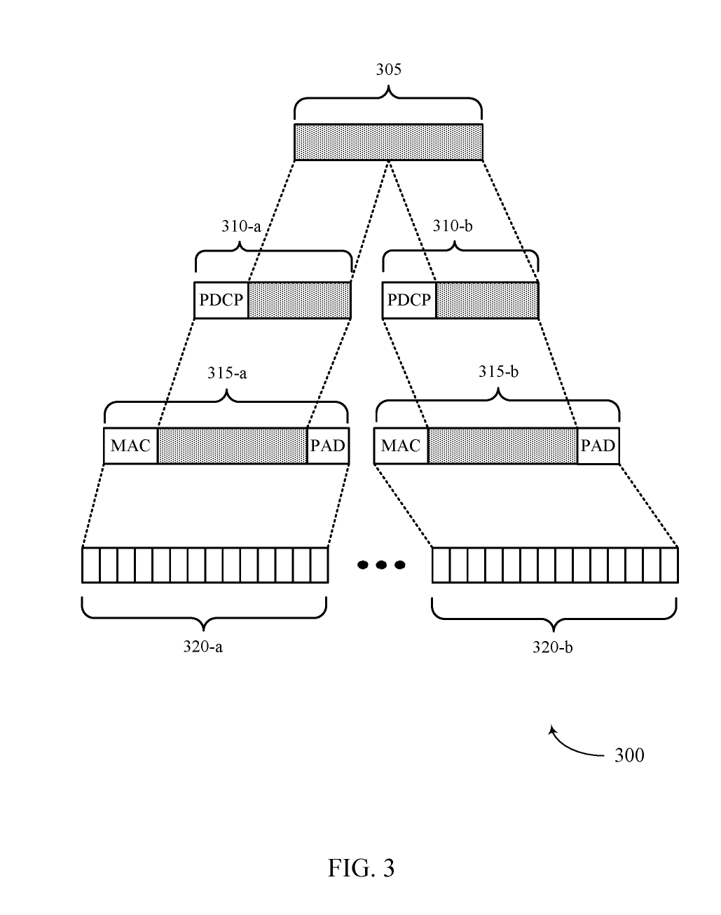

FIG. 3 illustrates an example of a protocol layer structure 300 for segmentation at the PDCP layer in accordance with various aspects of the present disclosure. Protocol layer structure 300 may represent a manner of communicating between a UE 115 and a base station 105 as described with reference to FIGS. 1-2. On the transmitter side, packets sent to a lower layer may be known as SDUs, and processed packets leaving a layer with protocol headers attached may be known as PDUs. On the receiver side, PDUs enter a layer, protocol headers are removed, the data may be processed, and SDUs may be passed on to higher layers.

From the transmitter perspective a PDCP SDU 305, such as an IP packet, may be received and passed to a PDCP entity, where it may be divided into one or more segments. The segments may be ciphered and a PDCP header may be appended, which may include a sequence number and an identifier identifying which portion of PDCP SDU 305 is contained in the segment. This may result in several PDCP PDUs 310, such as PDCP PDU 310-a and PDCP PDU 310-b.

The PDCP PDUs 310 may be passed on to the MAC layer as MAC SDUs. A MAC header may be prepended and padding bits may be added to the end to ensure that the resulting MAC PDUs 315, such as MAC PDU 315-a and MAC PDU 315-b, are of a proper or standard size. The MAC PDUs 315 may then be passed to the PHY layer as TBs and mapped to PHY layer resources 320-a and 320-b.

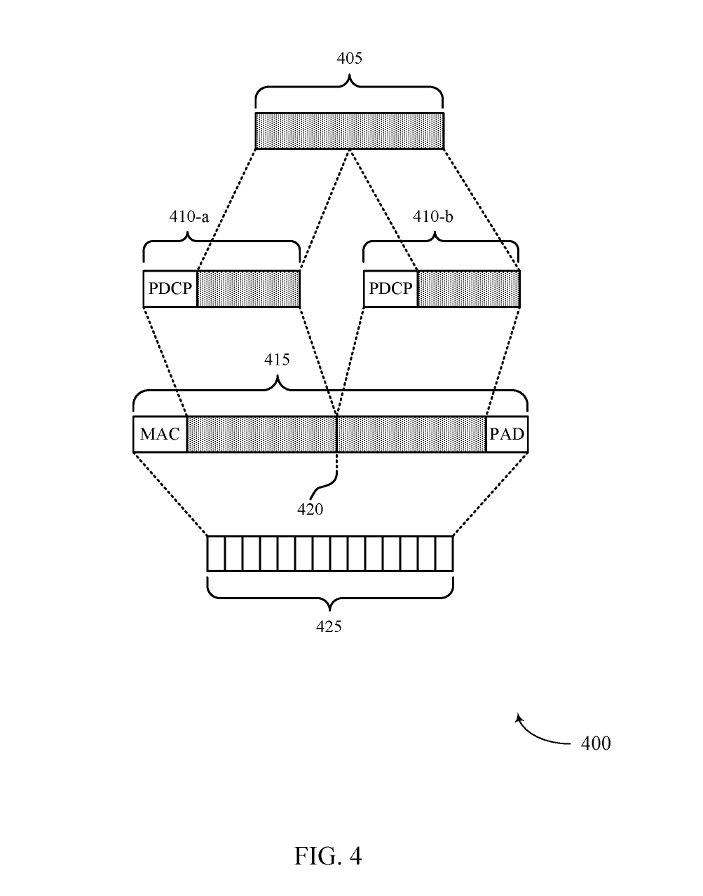

FIG. 4 illustrates an example of a protocol layer structure 400 for segmentation at the PDCP layer in accordance with various aspects of the present disclosure. Protocol layer structure 400 may represent a manner of communicating between a UE 115 and a base station 105 as described with reference to FIGS. 1-2. Protocol layer structure 400 illustrates an example in which multiple PDCP PDUs may be multiplexed in a MAC PDU.

From the transmitter perspective, a PDCP SDU 405 (e.g., an IP packet) may be received and passed to a PDCP entity, where it may be divided or segmented into one or more segments. The one or more segments may be ciphered and a PDCP header may be appended, which may include a sequence number and an identifier for which portion of PDCP SDU 405 is contained in each segment. This may result in multiple PDCP PDUs 410, such as PDCP PDU 410-a (e.g., including a first portion of PDCP SDU 405) and PDCP PDU 410-b (e.g., including a second portion of PDCP SDU 405).

In some cases, the size of the multiple PDCP PDUs 410 may be selected to enable multiplexing of the multiple PDCP PDUs 410 (e.g., PDCP PDU 410-a and PDCP PDU 410-b) into a MAC PDU 415. The length of each PDCP PDU 410 in MAC PDU 415 may be indicated in a MAC header. In some examples, several disjoint MAC PDUs 415 may be sent during retransmission. The PDCP layer may also communicate one or more PDCP PDU boundaries with the MAC layer (e.g. PDCP PDU boundary 420 between PDCP PDU 410-a and PDCP PDU 410-b), which may be used to determine a TB size for retransmission. The MAC PDUs 415 may then be passed to the PHY layer as TBs and mapped to PHY layer resources 425.

In some cases, a MAC PDU 415 that includes one or more PDCP PDUs 410 (e.g., including PDCP PDU 410-a and PDCP PDU 410-b) may be resegmented at PDCP PDU boundary 420. For example, MAC PDU 415 may be resegmented such that PDCP PDU 410-a and PDCP PDU 410-b are complete when received at a receiver. That is, PDCP PDU 410-a and PDCP PDU 410-b may not be segmented when MAC PDU 415 is resegmented. In some cases, resegmentation of the MAC PDU 415 may occur prior to transmission, prior to retransmission, or both.

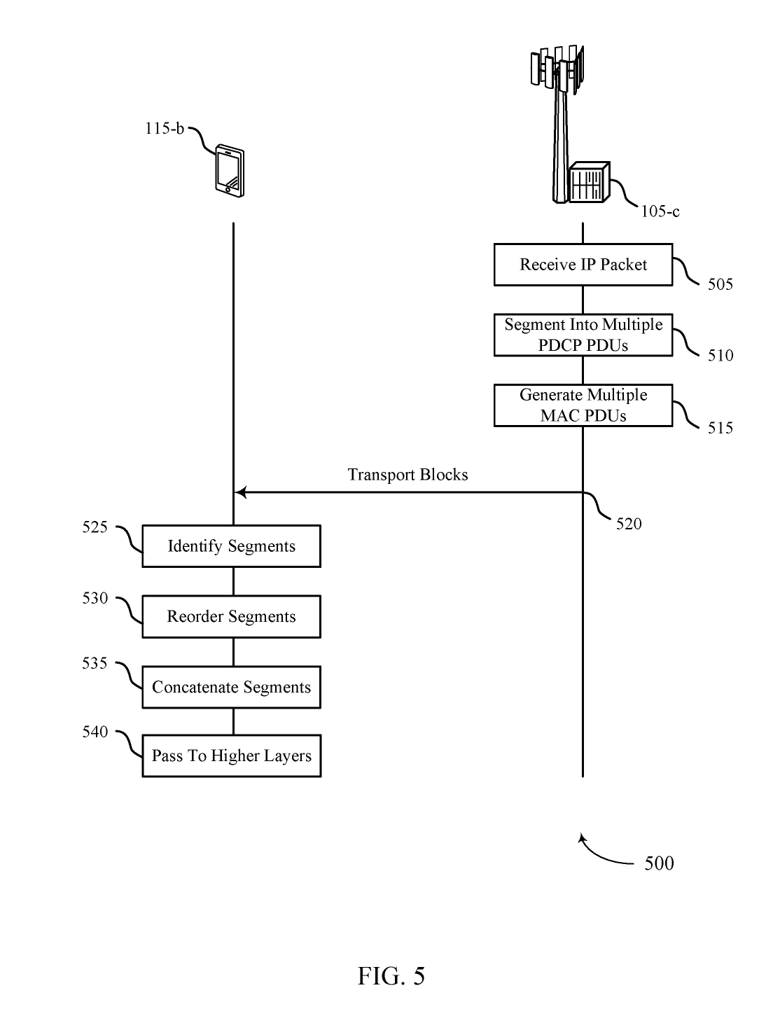

FIG. 5 illustrates an example of a process flow 500 in a system that supports segmentation at the PDCP layer in accordance with various aspects of the present disclosure. Process flow 500 may include a UE 115-b and base station 105-c, which may be examples of a UE 115 and base station 105 described with reference to FIGS. 1-2. In some cases, UE 115-b may also communicate with other base stations 105 using, for example, carrier aggregation or dual connectivity operations. Although process flow 500 represents base station 105-c as the transmitter and UE 115-b as the receiver (e.g., for downlink communications), the devices may also participate in uplink communications with UE 115-b as the transmitter and base station 105-c as the receiver (e.g., for uplink communications).

At 505, base station 105-c may receive a PDCP SDU such as an IP packet. In some cases, prior to receiving the PDCP SDU, base station 105-c may establish a split bearer dual connectivity configuration for UE 115-b.

At 510, base station 105-c may segment the PDCP SDU, and process the segments into multiple PDCP PDUs. That is, base station 105-c may divide a PDCP SDU into several PDCP segments based on a MAC layer transmission parameter, for instance. In some examples, the MAC layer transmission parameter includes a MAC PDU size, a MAC retransmission segmentation probability, or a MAC retransmission size, or a combination of such values. In some cases, the MAC retransmission size may be a predicted MAC retransmission size. Base station 105-c may cipher each of the set of PDCP segments and may append a PDCP header to each of the set of PDCP segments.

In some case, base station 105-c may exchange information between a MAC layer and a PDCP layer, such that a MAC layer transmission parameter may be based on the exchanged information. In some cases, base station 105-c may receive PDCP PDU size feedback from a secondary base station, such that dividing the PDCP SDU may be based on the PDCP PDU size feedback. In other examples, base station 105-c may identify a channel condition, and divide the PDCP SDU based at least in part on the channel condition. Base station 105-c may identify a retransmission configuration, such that dividing the PDCP SDU may be based on the retransmission configuration. In some examples, the PDCP segments may include a segment indicator and a length field in a PDCP header. In some examples, the MAC PDUs include the segment indicator and the length field for each of the PDCP segments in corresponding MAC headers.

At 515, base station 105-c may generate one or more MAC PDUs based on the PDCP PDUs. Base station 105-c may generate MAC PDUs from the PDCP segments. In some cases, base station 105-c may resegment the MAC PDUs at a PDCP PDU boundary. The resegmented MAC PDUs may contain full PDCP PDUs, but the number of MAC PDUs may be different from the number of corresponding PDCP PDUs (e.g., if one of the MAC PDUs contains multiple PDCP PDUs). The resegmentation may be performed prior to the initial transmission, or upon retransmission, or both. In some cases a MAC PDU may contain multiple PDCP PDUs, and the length of each PDCP PDU in the MAC PDU may be signaled in the MAC header.

At 520, base station 105-c may transmit the MAC PDUs as TBs, which may be received by UE 115-b. Thus, UE 115-b may receive the MAC PDUs. UE 115-b may generate several PDCP PDUs from the MAC PDUs.

At 525, UE 115-b may identify the PDCP PDU segments included in each TB. UE 115-b may identify a PDCP segment ID for each of the PDCP PDUs. The PDCP segment IDs may be contained in the PDCP headers, the MAC headers, or both.

At 530, UE 115-b may reorder the segments (e.g., based on sequence numbers and segment identifiers). That is, UE 115-b may reorder the PDCP PDUs based on the PDCP segment IDs, such that a concatenation may be based on the reordering.

At 535, UE 115-b may concatenate the PDCP PDU segments to form a data packet (e.g., an IP packet). UE 115-b may determine that the PDCP PDUs include a PDCP SDU based on the PDCP segment IDs. UE 115-b may concatenate the PDCP PDUs into the PDCP SDU based on this determination.

At 540, UE 115-b may pass the data packet on to higher layers (e.g., a web browser). In some examples, UE 115-b may determine that the plurality of PDCP PDUs are insufficient to generate a PDCP SDU based on the plurality of PDCP segment IDs, and may drop the PDCP PDUs based on the determination. In some cases, UE 115-b may determine that the PDCP PDUs include a beginning portion of a PDCP SDU based on the PDCP segment IDs. UE 115-b may deliver the beginning portion of the PDCP SDU to a higher layer based on this determination.

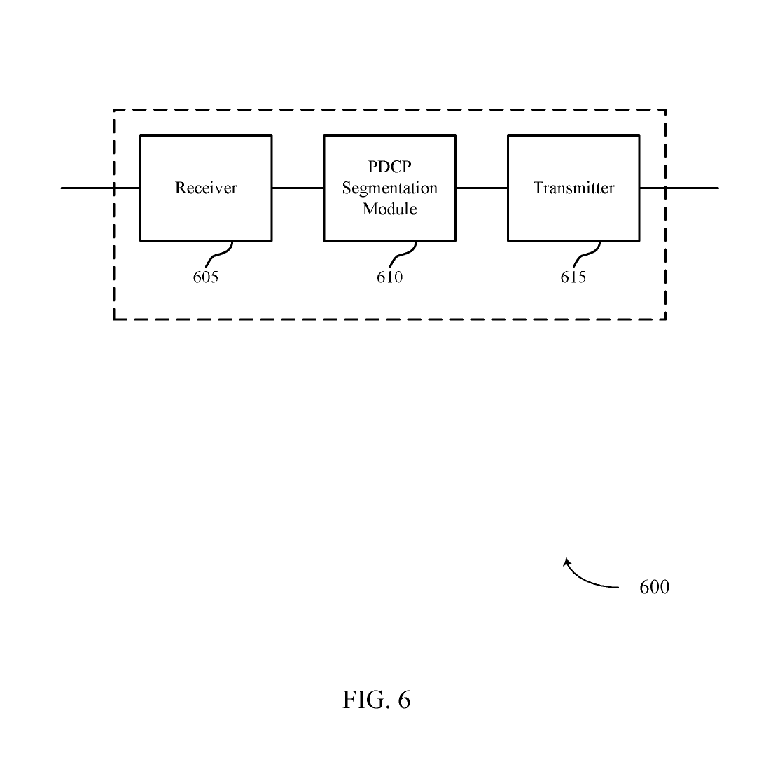

FIG. 6 shows a diagram of a wireless communications device 600 that supports segmentation at the PDCP layer in accordance with various aspects of the present disclosure. Wireless communications device 600 may be an example of aspects of a UE 115 described with reference to FIGS. 1-5. Wireless communications device 600 may include a receiver 605, a PDCP segmentation module 610, and a transmitter 615. Wireless communications device 600 may also include a processor and memory. Each of these components may be in communication with one another.

The receiver 605 may receive information such as packets, user data, or control information associated with various information channels (e.g., control channels, data channels, and information related to segmentation at the PDCP layer, etc.). Information may be passed on to the PDCP segmentation module 610, and to other components of wireless communications device 600. In some examples, the receiver 605 may receive the MAC PDUs (e.g., in the form of physical layer TBs).

The PDCP segmentation module 610 may divide a PDCP SDU into several PDCP segments based on a MAC layer transmission parameter, generate MAC PDUs from the PDCP segments, and transmit the MAC PDUs. The transmitter 615 may transmit signals received from other components of wireless communications device 600. In some examples, the transmitter 615 may be collocated with the receiver 605 in a transceiver module. The transmitter 615 may include a single antenna, or it may include a plurality of antennas. In some examples, the transmitter 615 may transmit the MAC PDUs (e.g., in the form of physical layer TBs).

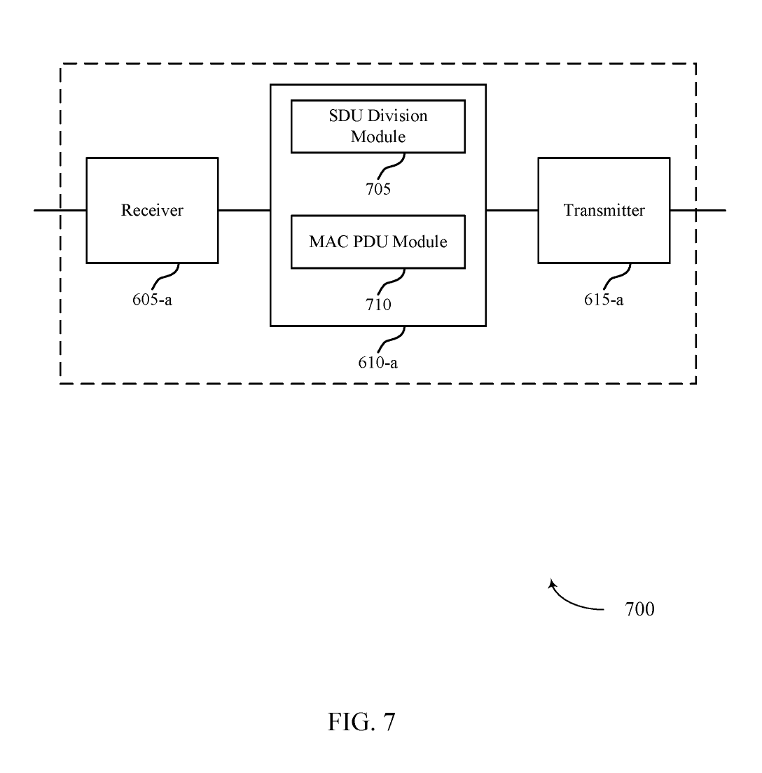

FIG. 7 shows a diagram of a wireless communications device 700 that supports segmentation at the PDCP layer in accordance with various aspects of the present disclosure. Wireless communications device 700 may be an example of aspects of a wireless communications device 600 or a UE 115 described with reference to FIGS. 1-6. Wireless communications device 700 may include a receiver 605-a, a PDCP segmentation module 610-a, and a transmitter 615-a. Wireless communications device 700 may also include a processor and memory. Each of these components may be in communication with one another. The PDCP segmentation module 610-a may also include an SDU division module 705, and a MAC PDU module 710.

The receiver 605-a may receive information, which may be passed on to PDCP segmentation module 610-a, and to other components of wireless communications device 700. The PDCP segmentation module 610-a may perform the operations described with reference to FIG. 6. The transmitter 615-a may transmit signals received from other components of wireless communications device 700.

The SDU division module 705 may divide a PDCP SDU into several PDCP segments based on, for example, a MAC layer transmission parameter as described with reference to FIGS. 1-5. In some examples, the MAC layer transmission parameter includes a MAC PDU size, a MAC retransmission segmentation probability, or a MAC retransmission size. Each of the PDCP segments may include a segment indicator and a length field in a PDCP header. In some examples, the MAC PDUs include the segment indicator and the length field for each of the PDCP segments in corresponding MAC headers. The MAC PDU module 710 may generate MAC PDUs from the PDCP segments as described with reference to FIGS. 1-5.

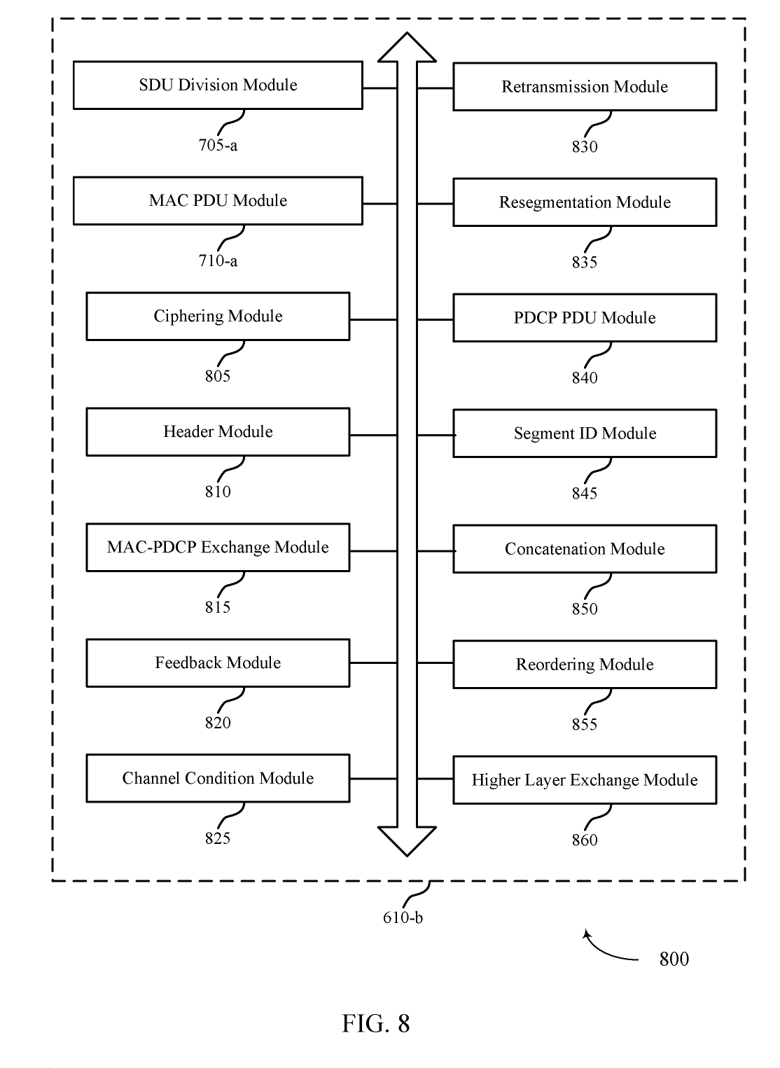

FIG. 8 shows a diagram 800 of a PDCP segmentation module 610-b which may be a component of a wireless communications device 600 or a wireless communications device 700 as described with reference to FIGS. 6-7, and which may support segmentation at the PDCP layer in accordance with various aspects of the present disclosure. The PDCP segmentation module 610-b may be an example of aspects of a PDCP segmentation module 610 described with reference to FIGS. 6-7. The PDCP segmentation module 610-b may include an SDU division module 705-a, and a MAC PDU module 710-a. Each of these modules may perform the functions described with reference to FIG. 7. The PDCP segmentation module 610-b may also include a ciphering module 805, a header module 810, a MAC-PDCP exchange module 815, a feedback module 820, a channel condition module 825, a retransmission module 830, a resegmentation module 835, a PDCP PDU module 840, a segment ID module 845, a concatenation module 850, a reordering module 855, and a higher layer exchange module 860.

The ciphering module 805 may cipher PDCP segments, such that generating the MAC PDUs may be based on the ciphering as described with reference to FIGS. 1-5. The header module 810 may append a PDCP header to each of the PDCP segments, such that generating the MAC PDUs may be based on appending the PDCP headers as described with reference to FIGS. 1-5. The MAC-PDCP exchange module 815 may exchange information between a MAC layer and a PDCP layer, such that the MAC layer transmission parameter may be based on the exchanged information as described with reference to FIGS. 1-5.

The feedback module 820 may receive PDCP PDU size feedback from a secondary base station, and dividing the PDCP SDU may be based on the PDCP PDU size feedback as described with reference to FIGS. 1-5. The feedback module 820 may also establish a split bearer dual connectivity configuration with a wireless communications device, such that receiving the PDCP PDU size feedback from the secondary base station may be based on the split bearer dual connectivity configuration.

The channel condition module 825 may identify a channel condition and dividing the PDCP SDU may be based on the channel condition as described with reference to FIGS. 1-5. The retransmission module 830 may identify a retransmission configuration and dividing the PDCP SDU may be based on the retransmission configuration as described with reference to FIGS. 1-5. The resegmentation module 835 may resegment the MAC PDUs at a PDCP PDU boundary as described with reference to FIGS. 1-5.

The PDCP PDU module 840 may generate PDCP PDUs from the MAC PDUs as described with reference to FIGS. 1-5. The PDCP PDU module 840 may also determine that the PDCP PDUs include a PDCP SDU based on the PDCP segment IDs. The PDCP PDU module 840 may, in some examples, determine that the PDCP PDUs are insufficient to generate a PDCP SDU based on the PDCP segment IDs. In some cases, the PDCP PDU module 840 may drop the PDCP PDUs based on the determination. The PDCP PDU module 840 may, in some examples, determine that the PDCP PDUs include a beginning portion of a PDCP SDU based on the PDCP segment IDs.

The segment ID module 845 may identify a PDCP segment ID for each of the PDCP PDUs as described with reference to FIGS. 1-5. The concatenation module 850 may concatenate the PDCP PDUs into the PDCP SDU based on the determination as described with reference to FIGS. 1-5. The reordering module 855 may reorder the PDCP PDUs based on the PDCP segment IDs, such that the concatenation may be based on the reordering as described with reference to FIGS. 1-5. The higher layer exchange module 860 may deliver the beginning portion of the PDCP SDU to a higher layer based on the determination as described with reference to FIGS. 1-5.

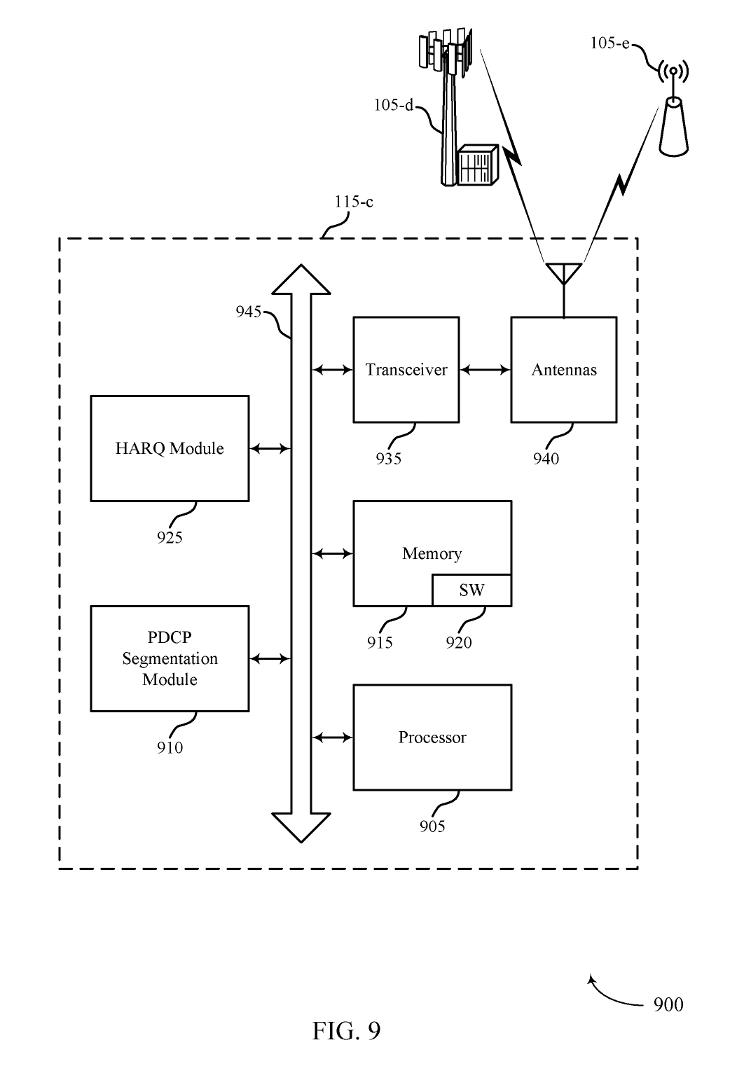

FIG. 9 shows a diagram of a system 900 including a UE 115 that supports segmentation at the PDCP layer in accordance with various aspects of the present disclosure. System 900 may include UE 115-c, which may be an example of a wireless communications device 600, a wireless communications device 700, or a UE 115 as described with reference to FIGS. 1, 2, and 6-8. UE 115-c may include a PDCP segmentation module 910, which may be an example of a PDCP segmentation module 610 described with reference to FIGS. 6-8. UE 115-c may, in some examples, include a HARQ module 925. UE 115-c may also include components for bi-directional voice and data communications including components for transmitting communications and components for receiving communications. For example, UE 115-c may communicate bi-directionally with base station 105-d or base station 105-e (e.g., in dual connectivity operation). The HARQ module 925 may perform MAC layer HARQ operations as described with reference to FIG. 1. In some cases, the PDCP segmentation may be based on a HARQ retransmission configuration.

UE 115-c may also include a processor 905, memory 915 (including software (SW) 920), a transceiver 935, and one or more antenna(s) 940, each of which may communicate, directly or indirectly, with one another (e.g., via buses 945). The transceiver 935 may communicate bi-directionally, via the antenna(s) 940 or wired or wireless links, with one or more networks, as described above. For example, the transceiver 935 may communicate bi-directionally with a base station 105 or another UE 115. The transceiver 935 may include a modem to modulate the packets and provide the modulated packets to the antenna(s) 940 for transmission, and to demodulate packets received from the antenna(s) 940.

While UE 115-c may include a single antenna 940, UE 115-c may also have multiple antennas 940 capable of concurrently transmitting or receiving multiple wireless transmissions.

The memory 915 may include random access memory (RAM) and read only memory (ROM). The memory 915 may store computer-readable, computer-executable software/firmware code 920 including instructions that, when executed, cause the processor 905 to perform various functions described herein (e.g., segmentation at the PDCP layer, etc.). Alternatively, the software/firmware code 920 may not be directly executable by the processor 905 but cause a computer (e.g., when compiled and executed) to perform functions described herein. The processor 905 may include an intelligent hardware device, (e.g., a central processing unit (CPU), a microcontroller, an application specific integrated circuit (ASIC), etc.

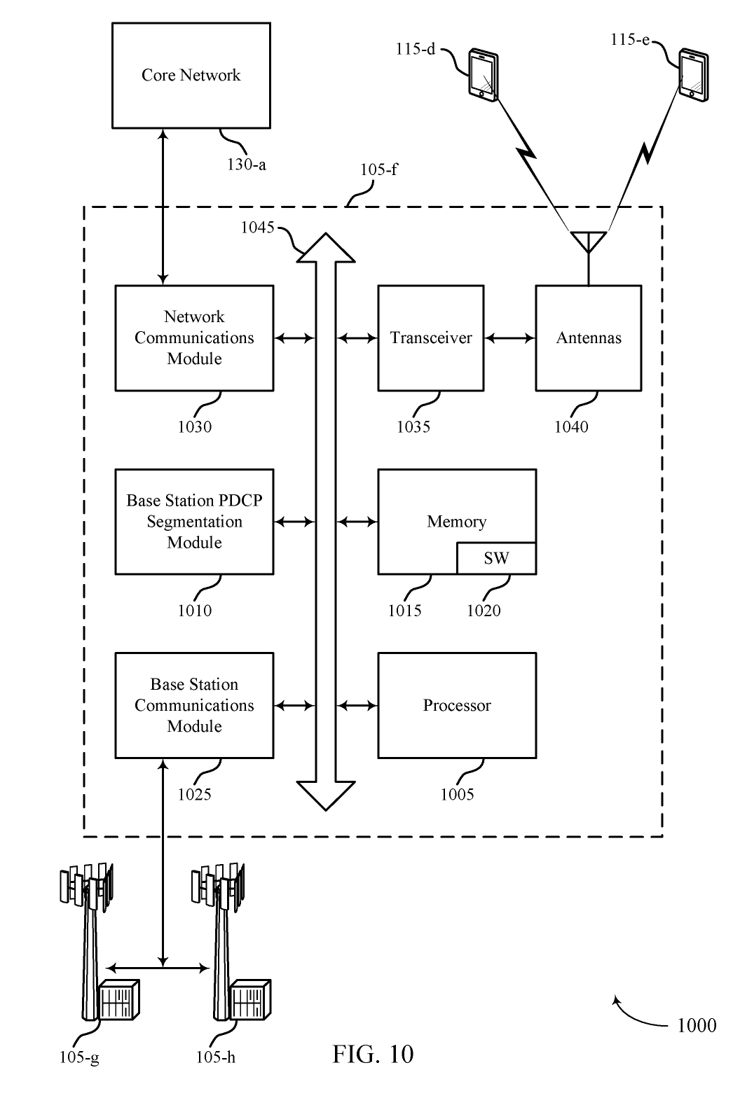

FIG. 10 shows a diagram of a system 1000 including a base station 105 that supports segmentation at the PDCP layer in accordance with various aspects of the present disclosure. System 1000 may include base station 105-f, which may be an example of a wireless communications device 600, a wireless communications device 700, or a base station 105 described with reference to FIGS. 1, 2 and 6-8. Base station 105-f may include a base station PDCP segmentation module 1010, which may be an example of a PDCP segmentation module 610 described with reference to FIGS. 6-8. Base station 105-f may also include components for bi-directional voice and data communications including components for transmitting communications and components for receiving communications. For example, base station 105-f may communicate bi-directionally with UE 115-d or UE 115-e.

In some cases, base station 105-f may have one or more wired backhaul links. Base station 105-f may have a wired backhaul link (e.g., S1 interface, etc.) to the core network 130. Base station 105-f may also communicate with other base stations 105, such as base station 105-g and base station 105-h via inter-base station backhaul links (e.g., an X2 interface). Each of the base stations 105 may communicate with UEs 115 using the same or different wireless communications technologies. In some cases, base station 105-f may communicate with other base stations such as 105-g or 105-h utilizing base station communication module 1025. In some examples, base station communication module 1025 may provide an X2 interface within a LTE/LTE-A wireless communication network technology to provide communication between some of the base stations 105. In some examples, base station 105-f may communicate with other base stations through core network 130-a. In some cases, base station 105-f may communicate with the core network 130-a through network communications module 1030.

The base station 105-f may include a processor 1005, memory 1015 (including software (SW) 1020), transceiver 1035, and antenna(s) 1040, which each may be in communication, directly or indirectly, with one another (e.g., over bus system 1045). The transceivers 1035 may be configured to communicate bi-directionally, via the antenna(s) 1040, with the UEs 115, which may be multi-mode devices. The transceiver 1035 (or other components of the base station 105-f) may also be configured to communicate bi-directionally, via the antennas 1040, with one or more other base stations (not shown). The transceiver 1035 may include a modem configured to modulate the packets and provide the modulated packets to the antennas 1040 for transmission, and to demodulate packets received from the antennas 1040. The base station 105-f may include multiple transceivers 1035, each with one or more associated antennas 1040. The transceiver may be an example of a combined receiver 605 and transmitter 615 of FIGS. 6-7.

The memory 1015 may include RAM and ROM. The memory 1015 may also store computer-readable, computer-executable software code 1020 containing instructions that are configured to, when executed, cause the processor 1005 to perform various functions described herein (e.g., segmentation at the PDCP layer, selecting coverage enhancement techniques, call processing, database management, message routing, etc.). Alternatively, the software code 1020 may not be directly executable by the processor 1005 but be configured to cause the computer, e.g., when compiled and executed, to perform functions described herein. The processor 1005 may include an intelligent hardware device, e.g., a CPU, a microcontroller, an ASIC, etc. The processor 1005 may include various special purpose processors such as encoders, queue processing modules, base band processors, radio head controllers, digital signal processors (DSPs), and the like.

The base station communication module 1025 may manage communications with other base stations 105. In some cases, a communications management module may include a controller or scheduler for controlling communications with UEs 115 in cooperation with other base stations 105. For example, the base station communication module 1025 may coordinate scheduling for transmissions to UEs 115 for various interference mitigation techniques such as beamforming or joint transmission.

The components of wireless communications device 600, wireless communications device 700, PDCP segmentation module 610, UE 115-c, or base station 105-f may, individually or collectively, be implemented with at least one ASIC adapted to perform some or all of the applicable functions in hardware. Alternatively, the functions may be performed by one or more other processing units (or cores), on at least one integrated circuit (IC). In other examples, other types of ICs may be used (e.g., Structured/platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

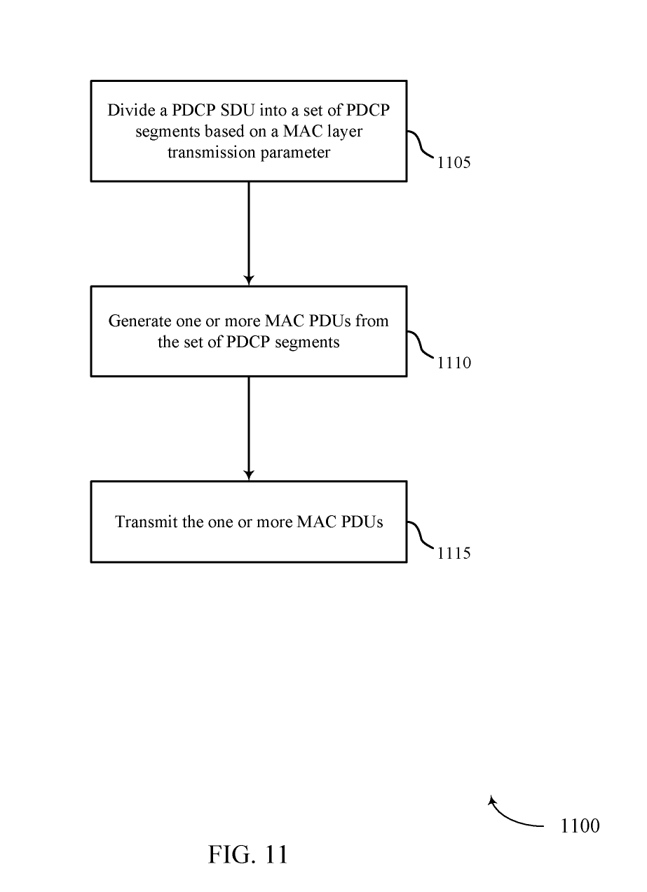

FIG. 11 shows a flowchart illustrating a method 1100 for segmentation at the PDCP layer in accordance with various aspects of the present disclosure. The operations of method 1100 may be implemented by a wireless communications device such as a UE 115, a base station 105 or its components as described with reference to FIGS. 1-10. For example, the operations of method 1100 may be performed by the PDCP segmentation module 610 as described with reference to FIGS. 6-8. In some examples, a wireless communications device may execute a set of codes to control the functional elements of the wireless communications device to perform the functions described below. Additionally or alternatively, the wireless communications device may perform aspects the functions described below using special-purpose hardware.

At block 1105, the wireless communications device may divide a PDCP SDU into a plurality of PDCP segments based at least in part on a MAC layer transmission parameter as described with reference to FIGS. 1-5. In certain examples, the operations of block 1105 may be performed by the SDU division module 705 as described with reference to FIG. 7.

At block 1110, the wireless communications device may generate one or more MAC PDUs from the plurality of PDCP segments as described with reference to FIGS. 1-5. In certain examples, the operations of block 1110 may be performed by the MAC PDU module 710 as described with reference to FIG. 7.

At block 1115, the wireless communications device may transmit the one or more MAC PDUs as described with reference to FIGS. 1-5. In certain examples, the operations of block 1115 may be performed by the transmitter 615 and/or PDCP segmentation module 610 as described with reference to FIGS. 6-8.

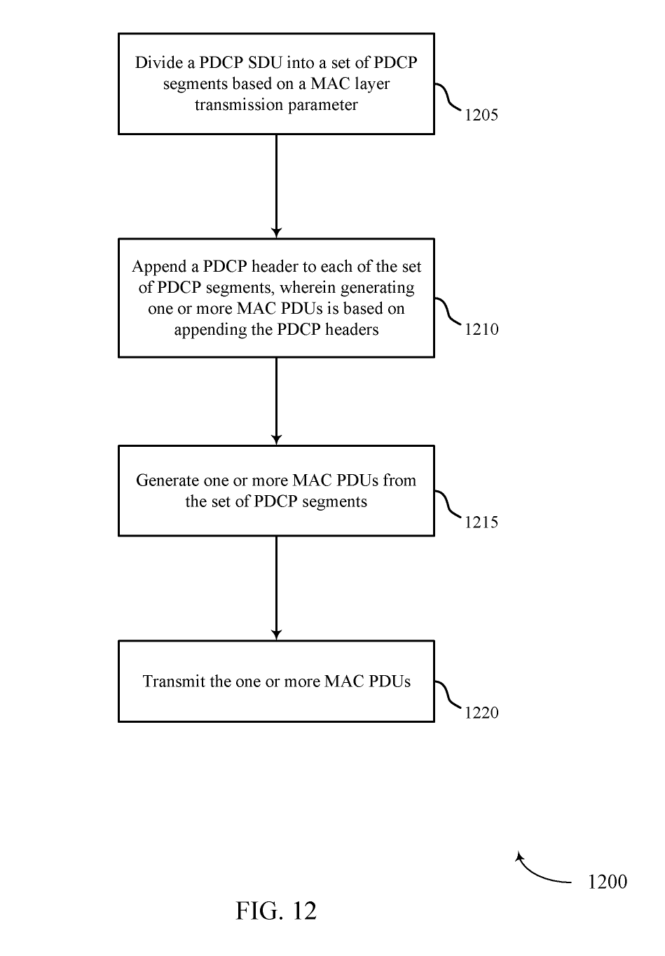

FIG. 12 shows a flowchart illustrating a method 1200 for segmentation at the PDCP layer in accordance with various aspects of the present disclosure. The operations of method 1200 may be implemented by a wireless communications device such as a UE 115, a base station 105 or its components as described with reference to FIGS. 1-10. For example, the operations of method 1200 may be performed by the PDCP segmentation module 610 as described with reference to FIGS. 6-8. In some examples, a wireless communications device may execute a set of codes to control the functional elements of the wireless communications device to perform the functions described below. Additionally or alternatively, the wireless communications device may perform aspects the functions described below using special-purpose hardware. The method 1200 may also incorporate aspects of method 1100 of FIG. 11.

At block 1205, the wireless communications device may divide a PDCP SDU into a plurality of PDCP segments based at least in part on a MAC layer transmission parameter as described with reference to FIGS. 1-5. In certain examples, the operations of block 1205 may be performed by the SDU division module 705 as described with reference to FIG. 7.

At block 1205, the wireless communications device may append a PDCP header to each of the plurality of PDCP segments, such that generating one or more MAC PDUs is based at least in part on appending the PDCP headers as described with reference to FIGS. 1-5. In certain examples, the operations of block 1210 may be performed by the header module 810 as described with reference to FIG. 8.

At block 1215, the wireless communications device may generate one or more MAC PDUs from the plurality of PDCP segments as described with reference to FIGS. 1-5. In certain examples, the operations of block 1215 may be performed by the MAC PDU module 710 as described with reference to FIGS. 7-8.

At block 1220, the wireless communications device may transmit the one or more

MAC PDUs as described with reference to FIGS. 1-5. In certain examples, the operations of block 1220 may be performed by the transmitter 615 and/or PDCP segmentation module 610 as described with reference to FIGS. 6-8.

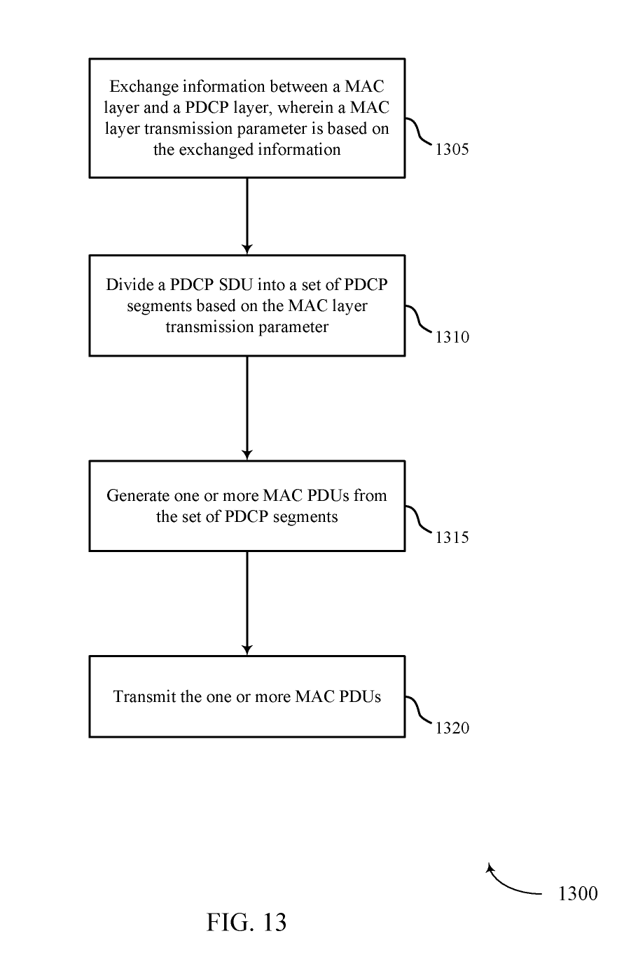

FIG. 13 shows a flowchart illustrating a method 1300 for segmentation at the PDCP layer in accordance with various aspects of the present disclosure. The operations of method 1300 may be implemented by a wireless communications device such as a UE 115, a base station 105 or its components as described with reference to FIGS. 1-10. For example, the operations of method 1300 may be performed by the PDCP segmentation module 610 as described with reference to FIGS. 6-8. In some examples, a wireless communications device may execute a set of codes to control the functional elements of the wireless communications device to perform the functions described below. Additionally or alternatively, the wireless communications device may perform aspects the functions described below using special-purpose hardware. The method 1300 may also incorporate aspects of methods 1100 and 1200 of FIGS. 11-12.

At block 1305, the wireless communications device may exchange information between a MAC layer and a PDCP layer, such that a MAC layer transmission parameter is based at least in part on the exchanged information as described with reference to FIGS. 1-5. In certain examples, the operations of block 1305 may be performed by the MAC-PDCP exchange module 815 as described with reference to FIG. 8.

At block 1310, the wireless communications device may divide a PDCP SDU into a plurality of PDCP segments based at least in part on the MAC layer transmission parameter as described with reference to FIGS. 1-5. In certain examples, the operations of block 1310 may be performed by the SDU division module 705 as described with reference to FIGS. 7-8.

At block 1315, the wireless communications device may generate one or more MAC PDUs from the plurality of PDCP segments as described with reference to FIGS. 1-5. In certain examples, the operations of block 1315 may be performed by the MAC PDU module 710 as described with reference to FIGS. 7-8.

At block 1320, the wireless communications device may transmit the one or more MAC PDUs as described with reference to FIGS. 1-5. In certain examples, the operations of block 1320 may be performed by the transmitter 615 and/or PDCP segmentation module 610 as described with reference to FIGS. 6-8.

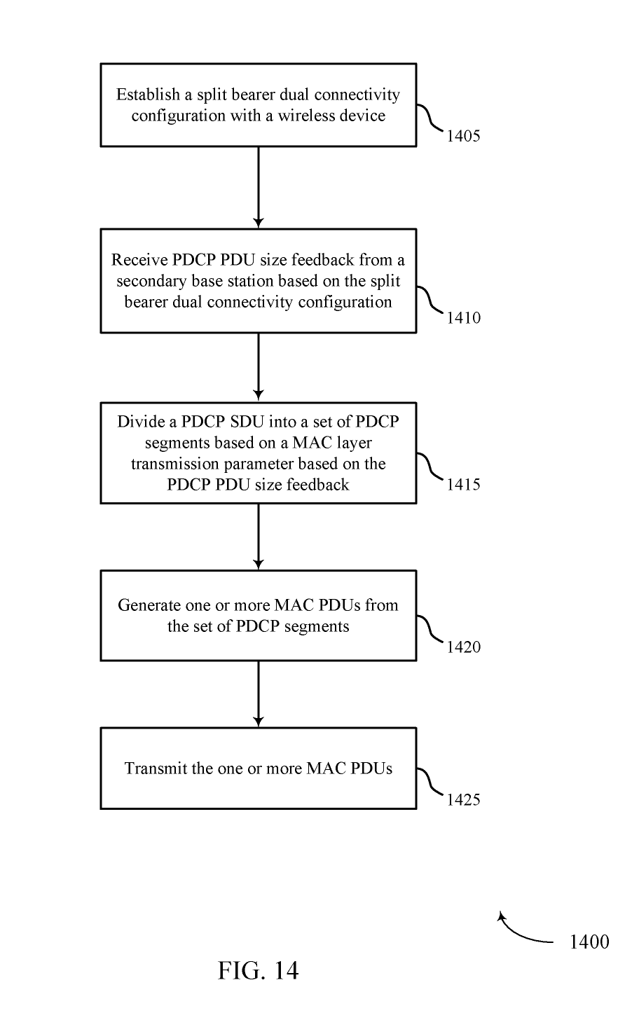

FIG. 14 shows a flowchart illustrating a method 1400 for segmentation at the PDCP layer in accordance with various aspects of the present disclosure. The operations of method 1400 may be implemented by a wireless communications device such as a base station 105 or its components as described with reference to FIGS. 1-10. For example, the operations of method 1400 may be performed by the PDCP segmentation module 610 as described with reference to FIGS. 6-8. In some examples, a wireless communications device may execute a set of codes to control the functional elements of the wireless communications device to perform the functions described below. Additionally or alternatively, the wireless communications device may perform aspects the functions described below using special-purpose hardware. The method 1400 may also incorporate aspects of methods 1100, 1200, and 1300 of FIGS. 11-13.

At block 1405, the wireless communications device may establish a split bearer dual connectivity configuration with a wireless communications device, such that receiving

PDCP PDU size feedback from the secondary base station is based at least in part on the split bearer dual connectivity configuration as described with reference to FIGS. 1-5. In certain examples, the operations of block 1405 may be performed by the feedback module 820 as described with reference to FIG. 8.

At block 1410, the wireless communications device may receive PDCP PDU size feedback from a secondary base station, such that dividing a PDCP SDU is based at least in part on the PDCP PDU size feedback as described with reference to FIGS. 1-5. In certain examples, the operations of block 1410 may be performed by the feedback module 820 as described with reference to FIG. 8.

At block 1415, the wireless communications device may divide a PDCP SDU into a plurality of PDCP segments based at least in part on a MAC layer transmission parameter as described with reference to FIGS. 1-5. In certain examples, the operations of block 1415 may be performed by the SDU division module 705 as described with reference to FIGS. 7-8.

At block 1420, the wireless communications device may generate one or more MAC PDUs from the plurality of PDCP segments as described with reference to FIGS. 1-5. In certain examples, the operations of block 1420 may be performed by the MAC PDU module 710 as described with reference to FIGS. 7-8.

At block 1425, the wireless communications device may transmit the one or more MAC PDUs as described with reference to FIGS. 1-5. In certain examples, the operations of block 1425 may be performed by the transmitter 615 and/or PDCP segmentation module 610 as described with reference to FIGS. 6-8.

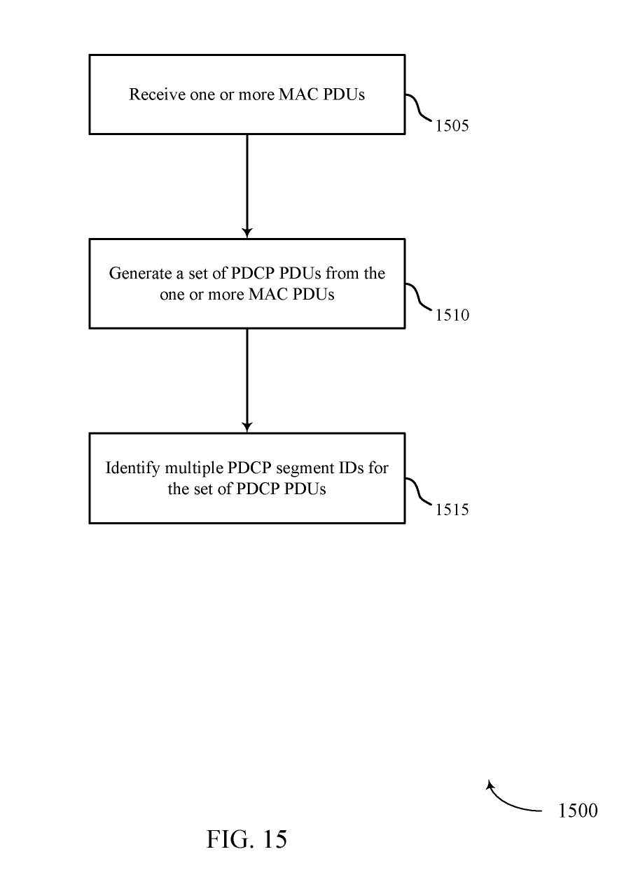

FIG. 15 shows a flowchart illustrating a method 1500 for segmentation at the PDCP layer in accordance with various aspects of the present disclosure. The operations of method 1500 may be implemented by a wireless communications device such as a UE 115, a base station 105 or its components as described with reference to FIGS. 1-10. For example, the operations of method 1500 may be performed by the PDCP segmentation module 610 as described with reference to FIGS. 6-8. In some examples, a wireless device may execute a set of codes to control the functional elements of the wireless communications device to perform the functions described below. Additionally or alternatively, the wireless communications device may perform aspects the functions described below using special-purpose hardware. The method 1500 may also incorporate aspects of methods 1100, 1200, 1300, and 1400 of FIGS. 11-14.

At block 1505, the wireless communications device may receive one or more MAC PDUs as described with reference to FIGS. 1-5. In certain examples, the operations of block 1505 may be performed by the receiver 605 and/or PDCP segmentation module 610 as described with reference to FIGS. 6-8.

At block 1510, the wireless communications device may generate a plurality of PDCP PDUs from the one or more MAC PDUs as described with reference to FIGS. 1-5. In certain examples, the operations of block 1510 may be performed by the PDCP PDU module 840 as described with reference to FIG. 8.

At block 1515, the wireless communications device may identify multiple PDCP segment IDs for the plurality of PDCP PDUs as described with reference to FIGS. 1-5. In certain examples, the operations of block 1515 may be performed by the segment ID module 845 as described with reference to FIG. 8.

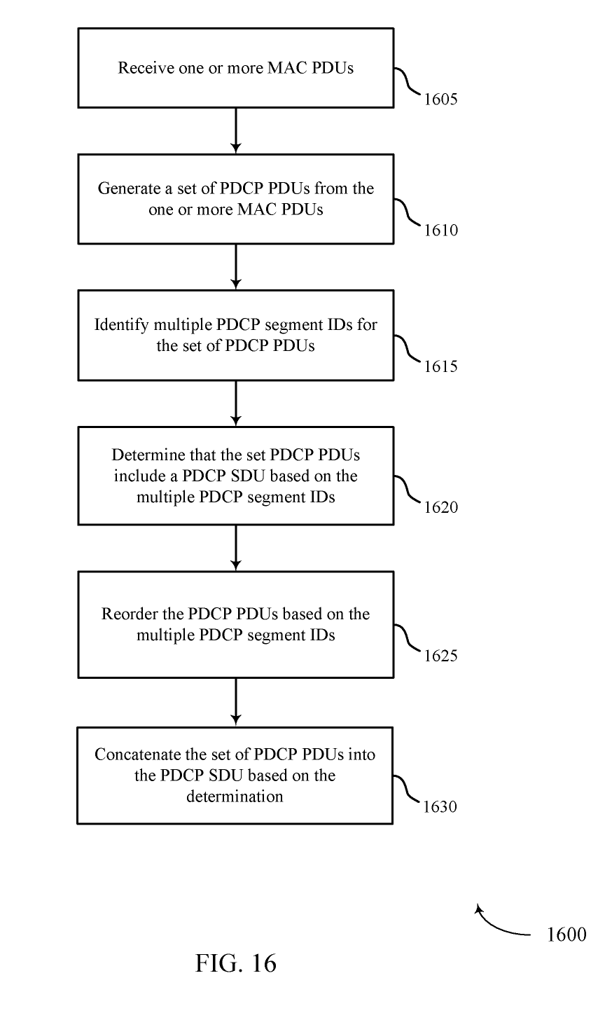

FIG. 16 shows a flowchart illustrating a method 1600 for segmentation at the PDCP layer in accordance with various aspects of the present disclosure. The operations of method 1600 may be implemented by a wireless communications device such as a UE 115, a base station 105 or its components as described with reference to FIGS. 1-10. For example, the operations of method 1600 may be performed by the PDCP segmentation module 610 as described with reference to FIGS. 6-8. In some examples, a wireless communications device may execute a set of codes to control the functional elements of the wireless communications device to perform the functions described below. Additionally or alternatively, the wireless communications device may perform aspects the functions described below using special-purpose hardware. The method 1600 may also incorporate aspects of methods 1100, 1200, 1300, 1400, and 1500 of FIGS. 11-15.

At block 1605, the wireless communications device may receive one or more MAC PDUs as described with reference to FIGS. 1-5. In certain examples, the operations of block 1605 may be performed by the receiver 605 and/or PDCP segmentation module 610 as described with reference to FIGS. 6-8.

At block 1610, the wireless communications device may generate a plurality of PDCP PDUs from the one or more MAC PDUs as described with reference to FIGS. 1-5. In certain examples, the operations of block 1610 may be performed by the PDCP PDU module 840 as described with reference to FIG. 8.

At block 1615, the wireless communications device may identify multiple PDCP segment IDs for the plurality of PDCP PDUs as described with reference to FIGS. 1-5. In certain examples, the operations of block 1615 may be performed by the segment ID module 845 as described with reference to FIG. 8.

At block 1620, the wireless communications device may determine that the plurality of PDCP PDUs include a PDCP SDU based at least in part on the PDCP segment IDs as described with reference to FIGS. 1-5. In certain examples, the operations of block 1620 may be performed by the PDCP PDU module 840 as described with reference to FIG. 8.

At block 1625, the wireless communications device may reorder the PDCP PDUs based at least in part on the PDCP segment IDs, such that a concatenation is based at least in part on the reordering as described with reference to FIGS. 1-5. In certain examples, the operations of block 1625 may be performed by the reordering module 855 as described with reference to FIG. 8.

At block 1630, the wireless communications device may concatenate the plurality of PDCP PDUs into the PDCP SDU based at least in part on the determination as described with reference to FIGS. 1-5. In certain examples, the operations of block 1630 may be performed by the concatenation module 850 as described with reference to FIG. 8.

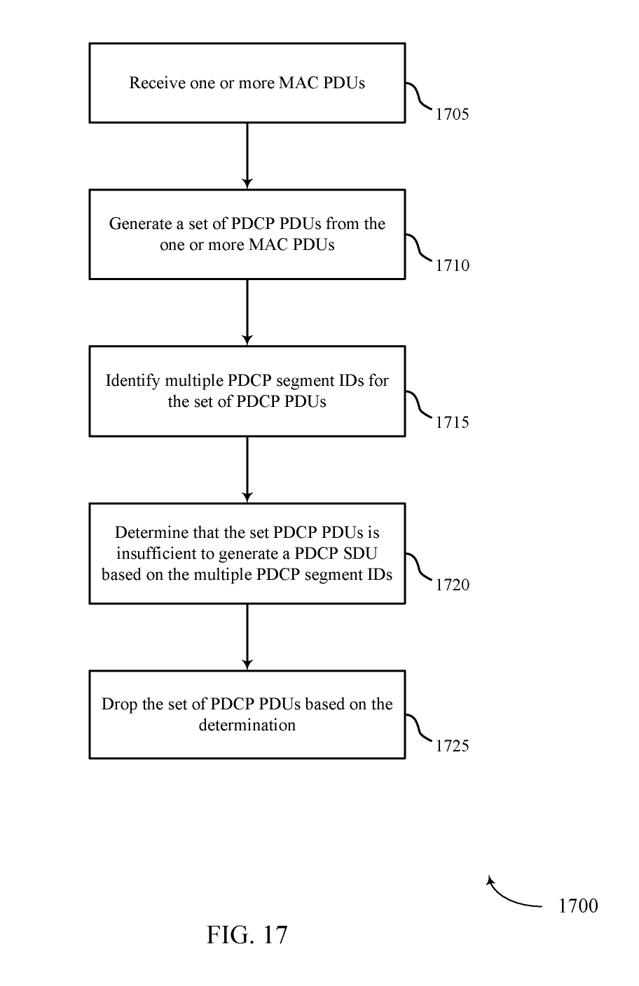

FIG. 17 shows a flowchart illustrating a method 1700 for segmentation at the PDCP layer in accordance with various aspects of the present disclosure. The operations of method 1700 may be implemented by a wireless communications device such as a UE 115, a base station 105 or its components as described with reference to FIGS. 1-10. For example, the operations of method 1700 may be performed by the PDCP segmentation module 610 as described with reference to FIGS. 6-8. In some examples, a wireless communications device may execute a set of codes to control the functional elements of the wireless communications device to perform the functions described below. Additionally or alternatively, the wireless communications device may perform aspects the functions described below using special-purpose hardware. The method 1700 may also incorporate aspects of methods 1100, 1200, 1300, 1400, 1500, and 1600 of FIGS. 11-16.

At block 1705, the wireless communications device may receive one or more MAC PDUs as described with reference to FIGS. 1-5. In certain examples, the operations of block 1705 may be performed by the receiver 605 and/or PDCP segmentation module 610 as described with reference to FIGS. 6-8.

At block 1710, the wireless communications device may generate a plurality of PDCP PDUs from the one or more MAC PDUs as described with reference to FIGS. 1-5. In certain examples, the operations of block 1710 may be performed by the PDCP PDU module 840 as described with reference to FIG. 8.

At block 1715, the wireless communications device may identify a plurality of PDCP segment IDs for the plurality of PDCP PDUs as described with reference to FIGS. 1-5. In certain examples, the operations of block 1715 may be performed by the segment ID module 845 as described with reference to FIG. 8.

At block 1720, the wireless communications device may determine that the plurality of PDCP PDUs is insufficient to generate a PDCP SDU based at least in part on the plurality of PDCP segment IDs as described with reference to FIGS. 1-5. In certain examples, the operations of block 1720 may be performed by the PDCP PDU module 840 as described with reference to FIG. 8.

At block 1725, the wireless communications device may drop the plurality of PDCP PDUs based at least in part on the determination as described with reference to FIGS. 1-5. In certain examples, the operations of block 1725 may be performed by the PDCP PDU module 840 as described with reference to FIG. 8.

Thus, methods 1100, 1200, 1300, 1400, 1500, 1600 and 1700 may provide for segmentation at the PDCP layer. It should be noted that methods 1100, 1200, 1300, 1400, 1500, 1600, and 1700 are example implementations, and that the operations of the methods 1100, 1200, 1300, 1400, 1500, 1600, and 1700 may be rearranged or otherwise modified such that other implementations are possible. In some examples, aspects from two or more of the methods 1100, 1200, 1300, 1400, 1500, 1600, and 1700 described with reference to FIG. 11, 12, 13, 14, 15, 16, or 17 may be combined.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile

Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP LTE and LTE-A are new releases of UMTS that use E-UTRA. UTRA, E-UTRA, UMTS, LTE, LTE-A, and GSM are described in documents from an organization named “3rd Generation Partnership Project” (3GPP).

CDMA2000 and UMB are described in documents from an organization named “3rd Generation Partnership Project 2” (3GPP2). The techniques described herein may be used for the systems and radio technologies mentioned above as well as other systems and radio technologies. The description herein, however, describes an LTE system for purposes of example, and LTE terminology is used in much of the description above, although the techniques are applicable beyond LTE applications.

In LTE/LTE-A networks, including such networks described herein, the term evolved node B (eNB) may be generally used to describe the base stations. The wireless communications system or systems described herein may include a heterogeneous LTE/LTE-A network in which different types of eNBs provide coverage for various geographical regions. For example, each eNB or base station may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNodeB (eNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions.

Each communication link described herein—including, for example, wireless communications system 100 and 200 of FIGS. 1 and 2—may include one or more carriers, where each carrier may be a signal made up of multiple sub-carriers (e.g., waveform signals of different frequencies). Each modulated signal may be sent on a different sub-carrier and may carry control information (e.g., reference signals, control channels, etc.), overhead information, user data, etc. The communication links described herein (e.g., communication links 125 of FIG. 1) may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of wireless communication, comprising:
dividing a packet data convergence protocol (PDCP) service data unit (SDU) into a plurality of PDCP segments based at least in part on a medium access control (MAC) layer transmission parameter;
generating one or more MAC protocol data units (PDUs) from the plurality of PDCP segments; and
transmitting the one or more MAC PDUs.

2. The method of claim 1, wherein the MAC layer transmission parameter comprises one or more of a MAC PDU size, a MAC retransmission segmentation probability, and a MAC retransmission size.

3. The method of claim 1, further comprising:
ciphering the plurality of PDCP segments, wherein the one or more MAC PDUs are generated based at least in part on the ciphering.

4. The method of claim 1, further comprising:
appending PDCP headers to the plurality of PDCP segments, wherein the one or more MAC PDUs are generated based at least in part on PDCP segments with appended PDCP headers.

5. The method of claim 1, further comprising:
exchanging information between a MAC layer and a PDCP layer, wherein the MAC layer transmission parameter is based at least in part on the exchanged information.

6. The method of claim 1, further comprising:
receiving PDCP PDU size feedback from a secondary base station, wherein dividing the PDCP SDU is based at least in part on the PDCP PDU size feedback.

7. The method of claim 6, further comprising:
establishing a split bearer dual connectivity configuration with a wireless device, wherein receiving the PDCP PDU size feedback from the secondary base station is based at least in part on the split bearer dual connectivity configuration.

8. The method of claim 1, further comprising:
identifying a channel condition, wherein a size of a PDCP segment of the plurality of PDCP segments is based at least in part on the channel condition.

9. The method of claim 1, further comprising:
identifying a retransmission configuration, wherein dividing the PDCP SDU is based at least in part on the retransmission configuration.

10. The method of claim 1, wherein a PDCP segment of the plurality of PDCP segments comprises a segment indicator and a length field in a PDCP header.

11. The method of claim 10, wherein the one or more MAC PDUs comprise the segment indicator and the length field for the PDCP segment in one or more corresponding MAC headers.

12. The method of claim 1, further comprising:
resegmenting the one or more MAC PDUs at a PDCP PDU boundary, wherein the one or more resegmented MAC PDUs include one or more non-segmented PDCP PDUs.

13. A method of wireless communication, comprising:
receiving one or more medium access control (MAC) protocol data units (PDUs);
generating a plurality of packet data convergence protocol (PDCP) PDUs from the one or more MAC PDUs; and
identifying a plurality of PDCP segment identifications (IDs) for the plurality of PDCP PDUs.

14. The method of claim 13, further comprising:
determining that the plurality of PDCP PDUs comprise a PDCP service data unit (SDU) based at least in part on the plurality of PDCP segment IDs; and
concatenating the plurality of PDCP PDUs into the PDCP SDU based at least in part on the determination.

15. The method of claim 14, further comprising:
reordering the plurality of PDCP PDUs based at least in part on the plurality of PDCP segment IDs, wherein the concatenation is based at least in part on the reordering.

16. The method of claim 13, further comprising:
determining that the plurality of PDCP PDUs are insufficient to generate a PDCP service data unit (SDU) based at least in part on the plurality of PDCP segment IDs; and
dropping the plurality of PDCP PDUs based at least in part on the determination.

17. The method of claim 13, further comprising:
determining that the plurality of PDCP PDUs comprise a beginning portion of a PDCP service data unit (SDU) based at least in part on the plurality of PDCP segment IDs; and
delivering the beginning portion of the PDCP SDU to a higher layer based at least in part on the determination.

18. An apparatus for wireless communication, comprising:
a processor;
memory in electronic communication with the processor; and
instructions stored in the memory and executable by the processor to cause the apparatus to:
divide a packet data convergence protocol (PDCP) service data unit (SDU) into a plurality of PDCP segments based at least in part on a medium access control (MAC) layer transmission parameter;
generate one or more MAC protocol data units (PDUs) from the plurality of PDCP segments; and
transmit the one or more MAC PDUs.

19. The apparatus of claim 18 wherein the MAC layer transmission parameter comprises one or more of a MAC PDU size, a MAC retransmission segmentation probability, and a MAC retransmission size.

20. The apparatus of claim 18, wherein the instructions are executable by the processor to cause the apparatus to:
cipher the plurality of PDCP segments, wherein the one or more MAC PDUs are generated based at least in part on the ciphering.
